(19) United States
(12) Patent Application Publication
(10) Pub. No.: US 2019/0141361 A1
(43) Pub. Date: May 9, 2019

(54) SYSTEMS AND METHODS FOR SIGNALING OF AN IDENTIFIER OF A DATA CHANNEL

(71) Applicant: SHARP KABUSHIKI KAISHA, Sakai City, Osaka, WA (US)

(72) Inventor: SACHIN G. DESHPANDE, Camas, WA (US)

(21) Appl. No.: 16/095,316

(22) PCT Filed: Mar. 29, 2017
(86) PCT No.: PCT/JP2017/012848

§ 371 Date: Oct. 19, 2018

Related U.S. Application Data
(60) Provisional application No. 62/326,685, filed on Apr. 22, 2016.
(60) Provisional application No. 62/396,194, filed on Sep. 18, 2016.

(51) Int. Cl. H04N 21/2362; H04N 21/6408; H04N 21/438; H04N 21/2665; H04N 21/462; H04N 21/434

(52) U.S. Cl. CPC H04N 21/2362; H04N 21/6408; H04N 21/4345; H04N 21/2665; H04N 21/4622; H04N 21/4383

(57) ABSTRACT

A device may be configured to receive a service level signaling metadata fragment from a broadcast stream. The device may determine that media components forming the service are associated with a broadband delivery mechanism by parsing the metadata fragment. The device may retrieve the media components forming the service using the broadband delivery mechanism.

### CROSS-REFERENCE TO RELATED APPLICATIONS

This Nonprovisional application claims priority under 35 U.S.C. § 119 on Patent Application No. 62/326,685 on Apr. 22, 2016 and Patent Application No. 62/396,194 on Sep. 18, 2016, the entire contents of which are hereby incorporated by reference.

### TECHNICAL FIELD

The present disclosure relates to the field of interactive television.

### BACKGROUND ART

Digital media playback capabilities may be incorporated into a wide range of devices, including digital televisions, including so-called “smart” televisions, set-top boxes, laptop or desktop computers, tablet computers, digital recording devices, digital media players, video gaming devices, cellular phones, including so-called “smart” phones, dedicated video streaming devices, and the like. Digital media content (e.g., video and audio programming) may originate from a plurality of sources including, for example, over-the-air television providers, satellite television providers, cable television providers, online media service providers, including, so-called streaming service providers, and the like. Digital media content may be delivered over packet-switched networks, including bidirectional networks, such as Internet Protocol (IP) networks and unidirectional networks, such as digital broadcast networks.

Digital media content may be transmitted from a source to a receiver device (e.g., a digital television or a smart phone) according to a transmission standard. Examples of transmission standards include Digital Video Broadcasting (DVB) standards, Integrated Services Digital Broadcasting Standards (ISDB) standards, and standards developed by the Advanced Television Systems Committee (ATSC), including, for example, the ATSC 2.0 standard. The ATSC is currently developing the so-called ATSC 3.0 suite of standards. The ATSC 3.0 suite of standards seek to support a wide range of diverse services through diverse delivery mechanisms. For example, the ATSC 3.0 suite of standards seeks to support broadcast multimedia delivery, so-called broadcast streaming/file download multimedia delivery, so-called broadband streaming/file download multimedia delivery, and combinations thereof (i.e., “hybrid services”). An example of a hybrid service contemplated for the ATSC 3.0 suite of standards includes a receiver device receiving an over-the-air video broadcast (e.g., through a unidirectional transport) and receiving a synchronized secondary audio presentation (e.g., a secondary language) from an online media service provider through a packet network (i.e., through a bidirectional transport).

### SUMMARY OF INVENTION

In general, this disclosure describes techniques for signaling (or signalling) information that may be used to identify a data channel. It should be noted that although in some examples the techniques of this disclosure are described with respect to ATSC standards, the techniques described herein are generally applicable to any transmission standard. For example, the techniques described herein are generally applicable to any of DVB standards, ISDB standards, ATSC Standards, Digital Terrestrial Multimedia Broadcast (DTMB) standards, Digital Multimedia Broadcast (DMB) standards, Hybrid Broadcast and Broadband Television (HbbTV) standards, World Wide Web Consortium (W3C) standards, Universal Plug and Play (UPnP) standards, and other video encoding standards. Further, it should be noted that incorporation by reference of documents herein is for descriptive purposes and should not be constructed to limit and/or create ambiguity with respect to terms used herein. For example, in the case where one incorporated reference provides a different definition of a term than another incorporated reference and/or as the term is used herein, the term should be interpreted in a manner that broadly includes each respective definition and/or in a manner that includes each of the particular definitions in the alternative.

According to one example of the disclosure, a method for signaling information associated with one or more services associated with a data channel comprises signaling a syntax element identifying a data channel corresponding to respective media delivery sessions including media components forming the one or more services using service layer signaling.

According to another example of the disclosure, a device for signaling information associated with one or more services associated with a data channel comprises one or more processors configured to signal a syntax element identifying a data channel corresponding to respective media delivery sessions including media components forming the one or more services using service layer signaling.

According to another example of the disclosure, an apparatus comprises means for signaling a syntax element identifying a data channel corresponding to respective media delivery sessions including media components forming the one or more services using service layer signaling.

According to another example of the disclosure, a non-transitory computer-readable storage medium comprises instructions stored thereon that upon execution cause one or more processors of a device to signal a syntax element identifying a data channel corresponding to respective media delivery sessions including media components forming the one or more services using service layer signaling.

According to one example of the disclosure, a method for retrieving media components forming a service comprises receiving a service level signaling metadata fragment from a broadcast stream, determining that media components forming the service are associated with a broadband delivery mechanism by parsing information from the metadata fragment, and retrieving the media components forming the service using the broadband delivery mechanism.

According to another example of the disclosure, a device for retrieving media components forming a service comprises one or more processors configured to receive a service level signaling metadata fragment from a broadcast stream, determine that media components forming the service are associated with a broadband delivery mechanism by parsing information from the metadata fragment, and retrieve the media components forming the service using the broadband delivery mechanism.

According to another example of the disclosure, an apparatus comprises means for receiving a service level signaling metadata fragment from a broadcast stream, means for determining that media components forming the service are associated with a broadband delivery mechanism by parsing information from the metadata fragment, and means retrieving the media components forming the service using the broadband delivery mechanism.

According to another example of the disclosure, a non-transitory computer-readable storage medium comprises instructions stored thereon that upon execution cause one or more processors of a device to receive a service level signaling metadata fragment from a broadcast stream, determine that media components forming the service are associated with a broadband delivery mechanism by parsing information from the metadata fragment, and retrieve the media components forming the service using the broadband delivery mechanism.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example of content delivery protocol model according to one or more techniques of this disclosure.

FIG. 2 is a conceptual diagram illustrating an example of respective delivery mechanisms of a media service according to one or more techniques of this disclosure.

FIG. 3 is a block diagram illustrating an example of a system that may implement one or more techniques of this disclosure.

FIG. 4 is a block diagram illustrating an example of a service distribution engine that may implement one or more techniques of this disclosure.

FIG. 5 is a block diagram illustrating an example of a component encapsulator that may implement one or more techniques of this disclosure.

FIG. 6 is a block diagram illustrating an example of a receiver device that may implement one or more techniques of this disclosure.

### DESCRIPTION OF EMBODIMENTS

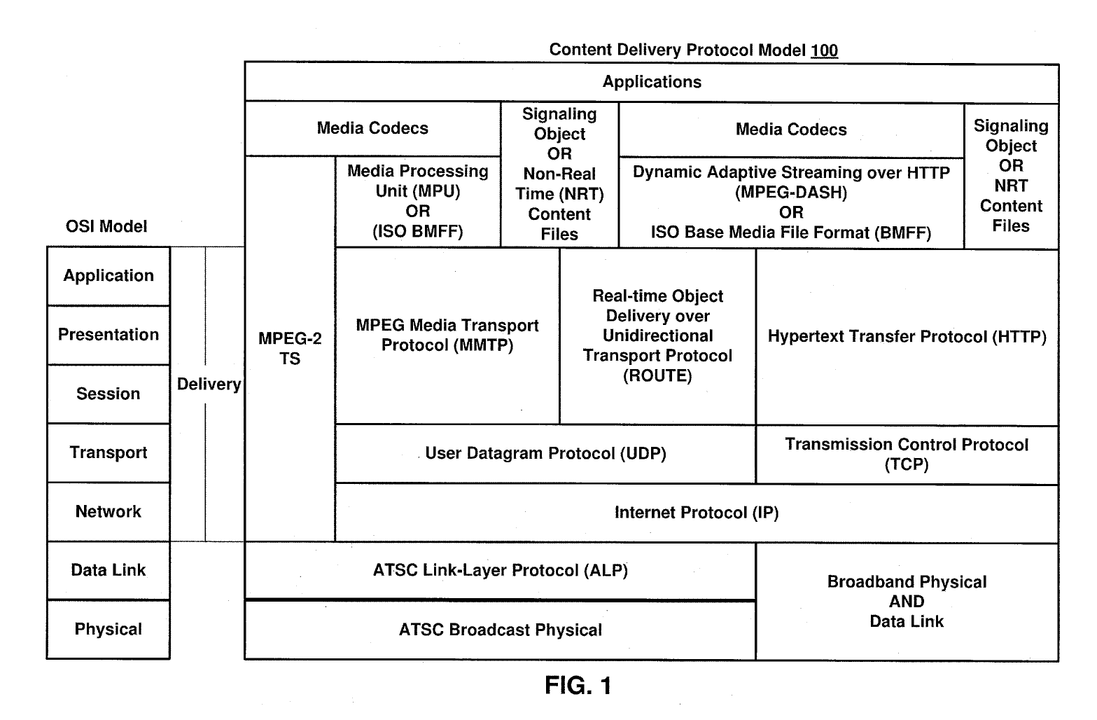

Computing devices and/or transmission systems may be based on models including one or more abstraction layers, where data at each abstraction layer is represented according to particular structures, e.g., packet structures, modulation schemes, etc. An example of a model including defined abstraction layers is the so-called Open Systems Interconnection (OSI) model illustrated in FIG. 1. The OSI model defines a 7-layer stack model, including an application layer, a presentation layer, a session layer, a transport layer, a network layer, a data link layer, and a physical layer. It should be noted that the use of the terms upper and lower with respect to describing the layers in a stack model may be based on the application layer being the uppermost layer and the physical layer being the lowermost layer. Further, in some cases, the term “Layer 1” or “L1” may be used to refer to a physical layer, the term “Layer 2” or “L2” may be used to refer to a link layer, and the term “Layer 3” or “L3” or “IP layer” may be used to refer to the network layer.

A physical layer may generally refer to a layer at which electrical signals form digital data. For example, a physical layer may refer to a layer that defines how modulated radio frequency (RF) symbols form a frame of digital data. A data link layer, which may also be referred to as link layer, may refer to an abstraction used prior to physical layer processing at a sending side and after physical layer reception at a receiving side. As used herein, a link layer may refer to an abstraction used to transport data from a network layer to a physical layer at a sending side and used to transport data from a physical layer to a network layer at a receiving side. It should be noted that a sending side and a receiving side are logical roles and a single device may operate as both a sending side in one instance and as a receiving side in another instance. A link layer may abstract various types of data (e.g., video, audio, or application files) encapsulated in particular packet types (e.g., Motion Picture Expert Group-Transport Stream (MPEG-TS) packets, Internet Protocol Version 4 (IPv4) packets, etc.) into a single generic format for processing by a physical layer. A network layer may generally refer to a layer at which logical addressing occurs. That is, a network layer may generally provide addressing information (e.g., Internet Protocol (IP) addresses, Universal Resource Locators (URLs), Universal Resource Identifiers (URIs), etc.) such that data packets can be delivered to a particular node (e.g., a computing device) within a network. As used herein, the term network layer may refer to a layer above a link layer and/or a layer having data in a structure such that it may be received for link layer processing. Each of a transport layer, a session layer, a presentation layer, and an application layer may define how data is delivered for use by a user application.

Transmission standards, including transmission standards currently under development, may include a content delivery protocol model specifying supported protocols for each layer and may further define one or more specific layer implementations. Referring again to FIG. 1, an example content delivery protocol model is illustrated. In the example illustrated in FIG. 1, content delivery protocol model 100 is “aligned” with the 7-layer OSI model for illustration purposes. It should be noted that such an illustration should not be construed to limit implementations of the content delivery protocol model 100 or the techniques described herein. Content delivery protocol model 100 may generally correspond to the currently proposed content delivery protocol model for the ATSC 3.0 suite of standards. Further, the techniques described herein may be implemented in a system configured to operate based on content delivery protocol model 100.

Aspects of the ATSC 3.0 suite of standards currently under development are described in Candidate Standards, revisions thereto, and Working Drafts (WD), each of which may include proposed aspects for inclusion in a published (i.e., “final” or “adopted”) version of an ATSC 3.0 standard. For example, ATSC Candidate Standard: Physical Layer Protocol, Doc. 532-230r21, 28 Sep. 2015, which is incorporated by reference in its entirety, describes specific proposed aspects of an ATSC 3.0 unidirectional physical layer implementation. The proposed ATSC 3.0 unidirectional physical layer includes a physical layer frame structure including a defined bootstrap, preamble, and data payload structure including one or more physical layer pipes (PLPs). A PLP may generally refer to a logical structure within an RF channel or a portion of an RF channel. The proposed ATSC 3.0 suite of standards refers to the abstraction for an RF Channel as a Broadcast Stream. The proposed ATSC 3.0 suite of standards further provides that a PLP is identified by a PLP identifier (PLPID), which is unique within the Broadcast Stream it belongs to. That is, a PLP may include a portion of an RF channel (e.g., a RF channel identified by a geographic area and frequency) having particular modulation and coding parameters.

The proposed ATSC 3.0 unidirectional physical layer provides that a single RF channel can contain one or more PLPs and each PLP may carry one or more services. In one example, multiple PLPs may carry a single service. In the proposed ATSC 3.0 suite of standards, the term service may be used to refer to a collection of media components presented to the user in aggregate (e.g., a video component, an audio component, and a sub-title component), where components may be of multiple media types, where a service can be either continuous or intermittent, where a service can be a real time service (e.g., multimedia presentation corresponding to a live event) or a non-real time service (e.g., a video on demand service, an electronic service guide service), and where a real time service may include a sequence of television programs. Further, the proposed ATSC 3.0 suite of standards defines five service categories as follows: (1) A “linear audio/video service” is a service consisting of one or more continuous video components, one or more continuous audio components, each associated with one or more of the video components, and one or more closed caption components, each associated with one or more of the audio components, all streamed in real time. A linear audio/video service may also contain app-based features; (2) A “linear audio-only service” is a service consisting of one or more continuous audio components and one or more closed caption components, each associated with one or more of the audio components, all streamed in real time. A linear audio-only service may also contain app-based features; (3) An “app-based service” is a service consisting entirely of app-based features, which provide the user interface for the service; An app-based feature is a service component consisting of an application, optional files to be used by the application, and optional notifications directing the application to take particular actions at particular times; (4) An “ESG (Electronic Service Guide) service. In one example, an application may be a collection of documents constituting an enhanced or interactive service. The documents of an application may include Hypertext Markup Language (HTML), JavaScript, Cascading Style Sheets (CSS), eXtensible Markup Language (XML) and multimedia files. It should be noted that the proposed ATSC 3.0 suite of standards specifies that new types of services may be defined in future versions. Thus, as used herein the term service may refer to a service described with respect to the proposed ATSC 3.0 suite of standards and/or other types of digital media services.

Referring to FIG. 1, content delivery protocol model 100 supports streaming and/or file download through the ATSC Broadcast Physical layer using MPEG Media Transport Protocol (MMTP) over User Datagram Protocol (UDP) and Internet Protocol (IP) and Real-time Object delivery over Unidirectional Transport (ROUTE) over UDP and IP. MMTP is described in ISO/IEC: ISO/IEC 23008-1, “Information technology—High efficiency coding and media delivery in heterogeneous environments-Part 1: MPEG media transport (MMT),” which is incorporated by reference herein in its entirety. An overview of ROUTE is provided in ATSC Candidate Standard: Signaling, Delivery, Synchronization, and Error Protection (A/331) Doc. 533-1-500r5, 14 Jan. 2016, Rev. 5 31 Mar. 2016 (hereinafter “A/331”), which is incorporated by reference in its entirety. It should be noted that although ATSC 3.0 uses the term broadcast in some contexts to refer to a unidirectional over-the-air transmission physical layer, the so-called ATSC 3.0 broadcast physical layer supports video delivery through streaming or file download. As such, the term broadcast as used herein should not be used to limit the manner in which video and associated data may be transported according to one or more techniques of this disclosure.

In the case where MMTP is used for streaming and/or file download through the ATSC Broadcast Physical layer, service component data (e.g., video data, audio data, closed caption data, etc.) may be encapsulated in a Media Processing Unit (MPU). MMTP defines a MPU as “a media data item that may be processed by an MMT entity and consumed by the presentation engine independently from other MPUs.” A logical grouping of MPUs may form an MMT asset, where MMTP defines an asset as “any multimedia data to be used for building a multimedia presentation. An asset is a logical grouping of MPUs that share the same asset identifier for carrying encoded media data.” For example, for a video component, MPUs may include groups of pictures (GOPs) that are independently decodable and an asset may include several MPUs forming a video sequence. One or more assets may form a MMT package, where a MMT package is a logical collection of media content. For example, an MMT package may include an asset corresponding to a video component and an asset corresponding to an audio component. A/331 provides that a single MMT package can be delivered over one or more MMTP sessions, where each MMTP session can be identified by a destination IP address and a destination UDP port number. Further, A/331 provides that multiple MMT packages can be delivered by a single MMTP session. A/331 provides that each PLP can carry one or more MMTP sessions. In addition, A/331 provides that one MMTP session can be carried by more than one PLP.

In the case where ROUTE is used for streaming and/or file download through the ATSC Broadcast Physical layer, service component data (e.g., video data, audio data, closed caption data, etc.) may be described in a Dynamic Adaptive Streaming over Hypertext Transport Protocol (HTTP) (DASH) Media Presentation (i.e., ROUTE/DASH). A DASH Media Presentation may correspond to a linear service or part of a linear service of a given duration defined by a service provider (e.g., a single TV program, or the set of contiguous linear TV programs over a period of time). Further, service component data may be associated with one or more segments carried over Layer Coding Transport (LCT) channels. For media delivery, an LCT channel may carry as a whole, or in part, a media component and a ROUTE session may be considered as the multiplex of LCT channels that carry constituent media components of one or more media presentations. That is, each ROUTE session may include one or more LCT channels, where LCT channels are subsets of a ROUTE session. Further, A/331 provides that one or more LCT channels may be included in a PLP and as such, a ROUTE session may be carried by one or more PLPs. Further, similar to a MMTP session, A/331 provides that a ROUTE session may be identified by a destination IP address and a destination UDP port number. It should be noted that a ROUTE session may further be identified by a source IP address. In A/331, an LCT channel is uniquely identified within the scope of the parent ROUTE session. Further, in A/331 one or more ROUTE sessions may be included within a Broadcast Stream (i.e., a particular RF channel).

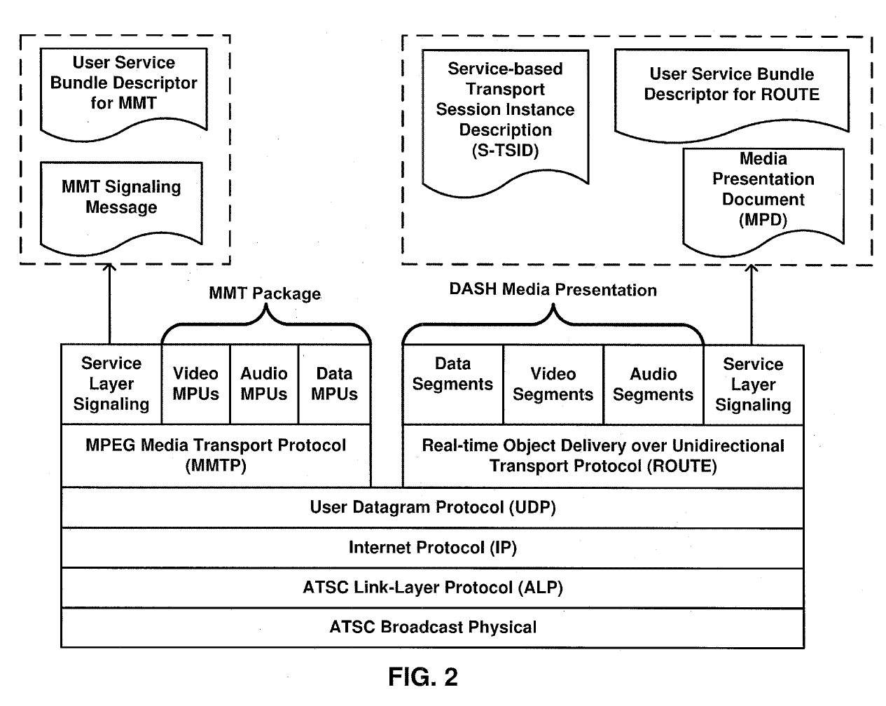

FIG. 2 is a conceptual diagram illustrating respective delivery mechanisms of a service as an MMT package and a service as DASH media presentation. As illustrated in FIG. 2, for each respective delivery mechanism corresponding service layer signaling occurs. In general, service layer (or level) signaling (SLS) may include information that enables a receiver to discover and/or access user services and their content components. In A/331, the service layer signaling is defined on a per-service level, and it describes the characteristics and access information of the service, such as a list of its content components and how to acquire them, and the receiver capabilities required to make a meaningful presentation of the service. A/331 provides specific data structures that may be included as part of a service layer signaling. That is, A/331 defines a set of message formats to be used to communicate signaling information necessary for the delivery and consumption of services by a receiver device. Referring to FIG. 2, for service layer signaling with respect to a MMTP delivery mechanism, A/331 service layer signaling includes a User Service Bundle Descriptor (USBD) and MMT specific signaling messages. For the sake of brevity, the format of the USBD for MMT is not described herein, however, reference is made to A/331. MMT specifies a signaling function that defines a set of message formats for signaling messages. MMT specifies message formats for carrying signaling tables, descriptors or delivery related information. For the sake of brevity, the format of the MMT signaling messages is not described herein, however, reference is made to A/331.

Referring again to FIG. 2, for service layer signaling with respect to a ROUTE/DASH delivery mechanism, A/331 service layer signaling includes a Service-based Transport Session Instance Description (S-TSID), a ROUTE/DASH User Service Bundle Descriptor (USBD), and a Media Presentation Document (MPD). Each of a S-TSID, a ROUTE/DASH USBD, and a MPD may include fragments that describe service layer properties. A fragment may include a set of XML-encoded metadata fragments. An S-TSID may include an XML fragment which provides the overall session description information for transport session(s) which carry the content components of an ATSC 3.0 service. A ROUTE/DASH USBD may include one of an XML fragment acting as signaling hub which describes details of technical information for an ATSC 3.0 service. A MPD may include an XML fragment that includes a formalized description of a media presentation for the purpose of providing streaming service. For example MPD may include an XML fragment that includes a formalized description of a DASH-IF (DASH Interoperability Forum) profile of a DASH Media Presentation. The contents of the MPD may provide the resource identifiers for streaming media segments and the context for the identified resources within the Media Presentation.

In one example, the metadata fragments may be carried over a dedicated LCT channel. In A/331, the dedicated LCT channel carrying the metadata fragments can be acquired using SLS bootstrapping information included in a Service List Table (SLT) included in so-called low level signaling (LLS). For a receiver device first encountering an emission, low level signaling provides an entry point for accessing services. The SLT in A/331 includes information which allows a receiver device to generate a list of services. In A/331, the SLT includes a broadcast stream identifier attribute, @bsid. As described above, a broadcast stream is an abstraction of an RF channel. A/331 provides the following definition from the attribute @bsid:
@bsid—Identifier of the whole Broadcast Stream. The value of bsid shall be unique on a regional level (for example, North America). An administrative or regulatory authority may play a role.

Further in A/331, for each service in the Broadcast Stream delivered via a ROUTE/DASH delivery mechanism, the SLT includes a unique identifier (i.e., a service_id), and the following SLS bootstrapping information: a destination IP address of the packets carrying SLS data for the service (i.e., @slsDestinationIpAddress), destination port number of the packets carrying SLS data for the service (@slsDestinationUdpPort), and optionally a source IP address of the packets carrying SLS data for the service (@slsSourceIpAddress). It should be noted that a MMTP session does not need to know source IP address (@slsSourceIpAddress). From the SLS bootstrapping information, a receiver device may obtain the ROUTE/DASH USBD fragment.

In A/331, the ROUTE/DASH USBD fragment includes service identification, device capability requirement information, references to other SLS fragments required to access the service and constituent media components, and metadata to enable a receiver device to determine the transport mode (e.g., broadcast and/or broadband) of service components. Table 1 provides the semantics of the ROUTE/DASH USBD fragment as provided in A/331. It should be noted that in Table 1, and other tables herein, a designated Data Type may correspond to definitions provided in XML Schema Definition (XSD) recommendations maintained by the World Wide Web Consortium (W3C). Further, it should be noted that in Table 1, and other tables herein, Use may correspond to cardinality of an element or attribute (i.e., the number of occurrences of the element or attribute).

TABLE 1

| Element or Attribute Name | | Use | Data Type | Description |
|---|---|---|---|---|
| bundleDescription | | | | Root element of the User Service Bundle |
| | | | | Description. |
| | userServiceDescription | | | A single instance of an ATSC 3.0 Service. |

| @globalServiceID | 1 | anyURI | A globally unique URI that identifies the |
|---|---|---|---|
| | | | ATSC 3.0 Service. |
| @serviceId | 1 | unsignedShort | Reference to corresponding service entry in |
| | | | the SLT. |
| @serviceStatus | 0 . . . 1 | boolean | Specify the status of this service as active or |
| | | | inactive. |
| @fullMPDUri | 1 | anyURI | Reference to an MPD fragment which |
| | | | contains descriptions for contents |
| | | | components of the ATSC 3.0 Service |
| | | | delivered over broadcast and optionally, also |
| | | | over broadband. |
| @sTSIDUri | 1 | anyURI | Reference to the S-TSID fragment which |
| | | | provides access related parameters for the |
| | | | Transport sessions carrying contents of this |
| | | | ATSC 3.0 Service. |
| name | 0 . . . N | string | Name of the ATSC 3.0 service. |

| | | | |
|---|---|---|---|
| @lang | 1 | language | Language of the ATSC 3.0 service name. |

| serviceLanguage | 0 . . . N | language | Available languages of the ATSC 3.0 |
|---|---|---|---|
| | | | service. |
| capabilityCode | 0 . . . 1 | string | Representation of the capabilities and |
| | | | capability groups, required in the receiver, to |
| | | | be able to create a meaningful presentation of |
| | | | the content of this ATSC service. |
| deliveryMethod | 1 . . . N | | Container of transport related information |

| | | pertaining to the contents of the service over |
|---|---|---|
| | | broadcast or broadband modes of access. |
| broadcastAppService | 1 . . . N | A DASH Representation delivered over |

| | | | broadcast, containing the corresponding |
|---|---|---|---|
| | | | media component(s) belonging to the ATSC |
| | | | 3.0 Service. |
| basePattern | 1 . . . N | string | A character pattern for use by the ATSC |

| | | receiver to match against any portion of the |
|---|---|---|
| | | Segment URL used by the DASH client to |
| | | request Media Segments of a parent |
| | | Representation. |
| unicastAppService | 0 . . . N | A DASH Representation delivered over |

| | | | broadband, containing the constituent media |
|---|---|---|---|
| | | | content component(s) belonging to the ATSC |
| | | | 3.0 Service. |
| basePattern | 1 . . . N | string | A character pattern for use by the ATSC |

receiver to match against any portion of the
Segment URL used by the DASH client to
request Media Segments of a parent
Representation.

A/331 provides the following additional description of the respective elements and attributed included in Table 1:
bundleDescription—Root element of the User Service Bundle Description.
UserServiceDescription—Container of information for a single ATSC 3.0 Service.
@globalServiceID—The globally unique URI value representing the identifier of the ATSC 3.0 service named in the parent USBD fragment. This attribute provides the linkage to, and its value shall be identical to that of the Service@globalServiceID attribute in the ESG.
@serviceId—A 16-bit integer value that identifies the ATSC 3.0 service named in the parent USBD fragment and whose uniqueness pertains to the scope of this Broadcast area. Its value shall be identical to that of the SLT.Service.serviceId attribute in the SLT which references the LCT channel carrying the USBD fragment for this service.
@serviceStatus—A boolean attribute which conveys the current status of this service as being active or inactive. When set to “1” or ‘true’, it is an indication that the service is active, and when set to “0” or ‘false’, it is an indication that the service is inactive. Its default value is “1” or ‘true’.
@fullMPDUri—URI reference to the MPD fragment that contains descriptions for content components of this ATSC 3.0 service which is delivered over broadcast and/or broadband.
@sTSIDUri—URI reference to the S-TSID fragment which contains transport/access related parameters for the LCT channels allocated to carry the content components of this ATSC 3.0 service.

In one example, the attributes @fullMPDUri and/or @sTSIDUri may not be signaled.
name—The name of this ATSC 3.0 service as given by one or more languages as defined by its lang attribute.
@lang—The language for the name of this ATSC 3.0 service, represented by formal natural language identifiers as defined by BCP 47 [Internet Engineering Task Force (IETF): Best Current Practice (BCP) 47, “Tags for Identifying Languages,” Internet Engineering Task Force, Reston, Va., September 2009.].
serviceLanguage—The language for the name of this ATSC 3.0 service, represented by formal natural language identifiers as defined by BCP 47.
deliveryMethod—The container of transport related information pertaining to the contents of this ATSC 3.0 service. This element contains information on the delivery mode (broadcast, broadband, or via both paths) for each of those content components.
broadcastAppService—Designation that the content item of this ATSC 3.0 service as requested by an application in the receiver, is delivered over broadcast, i.e. via the ROUTE protocol. The presence of this element may be used alone, or in conjunction with its child element basePattern, to determine whether the delivery path for that content is broadcast.
basePattern (under broadcastAppService)—A string value, typically in the form of a base URI, to be used for matching against the resource URL provided by the application for making a request of a content component of the ATSC 3.0 service. The occurrence of a full match of a broadcastAppService.basePattern value to a contiguous portion of the request URL shall be an indication to the receiver that the requested content is delivered by broadcast.
unicastAppService—Designation that the content item of this ATSC 3.0 service as requested by an application in the receiver, is delivered over broadband, via the HTTP protocol. The presence of this element may be used alone, or in conjunction with its child element basePattern, to determine whether the delivery path for that content is broadband.
basePattern (under unicastAppService)—A string value, typically in the form of a base URI, to be used for matching against the resource URL provided by the application for making a request of a content component of the ATSC 3.0 service. The occurrence of a full match of a unicastAppService.basePattern value to a contiguous portion of the request URL shall be an indication to the receiver that the requested content is delivered by broadband

It should be noted that with respect to Table 1, in the delivery method container (i.e. inside deliveryMethod element), the presence of broadcastAppService element is mandatory and the presence of unicastAppService element is optional. Further, A/331 does not provide a null value for basePattern element (under broadcastAppService element). As such, the ROUTE/DASH USBD fragment in A/331 implicitly requires that at least one content component of an ATSC 3.0 be delivered via a broadcast path. There may be cases where a service provider wishes to deliver all content components of a service via the broadband path and enable a receiver device to bootstrap the service using the SLT, USBD, and other service layer signaling. For example, a broadcaster may wish to provide an over-the-top service for which bootstrap signaling is provided via broadcast. In another example, a broadcaster may wish to provide an electronic service guide service via broadband and provide the bootstrap signaling via broadcast.

In A/331, the ROUTE/DASH USBD fragment is the top level or entry point SLS fragment and as such includes a reference to the S-TSID fragment (i.e., @sTSIDUri). In A/331, the S-TSID fragment, provides transport session descriptions for the one or more ROUTE sessions in which the media content components of a service are delivered, and descriptions of the delivery objects carried in those LCT channels. The S-TSID is the SLS metadata fragment that contains the overall transport session description information for the zero or more ROUTE sessions and constituent LCT channels in which the media content components of an ATSC 3.0 service are delivered. The S-TSID also includes file metadata for the delivery object or object flow carried in the LCT channels of the service, as well as additional information on the payload formats and content components carried in those LCT channels. Table 2 provides the semantics of the S-TSID fragment as provided in A/331.

TABLE 2

| Element and Attribute Names | | Use | Data Type | Description |
|---|---|---|---|---|
| S-TSID | | | | Service Transport Session Instance |
| | | | | Description |
| | @serviceId | 0 . . . 1 | unsignedShort | Reference to corresponding service element |
| | | | | in the USD. The value of this attribute shall |
| | | | | reference a service with a corresponding |
| | | | | value of ServiceId. |
| | RS | 1 . . . N | | ROUTE session |

| @bsid | 0 . . . 1 | unsignedShort | Identifier of the Broadcast Stream within |
|---|---|---|---|
| | | | which the content component(s) of the |
| | | | broadcastAppService are carried. When this |
| | | | attribute is absent, the default Broadcast |
| | | | Stream is the one whose PLPs carry SLS |
| | | | fragments for this ATSC 3.0 service. Its value |
| | | | shall be identical to that of the @bsid in the |
| | | | SLT. |
| @sIpAddr | 0 . . . 1 | string | Source IP address (default: current ROUTE |
| | | | session's source IP address) (M for non- |
| | | | primary session) |
| @dIpAddr | 0 . . . 1 | string | Destination IP address (default: current |
| | | | ROUTE session's destination IP address) (M |
| | | | for non-primary session) |
| @dport | 0 . . . 1 | unsignedShort | Destination port (default: current ROUTE |
| | | | session's destination port) (M for non- |
| | | | primary session) |
| LS | 1 . . . N | | LCT channel |

| | | | |
|---|---|---|---|
| @tsi | 1 | unsignedInt | TSI value |
| @bw | 0 . . . 1 | unsignedInt | Maximum bandwidth |
| @startTime | 0 . . . 1 | dateTime | Start time |
| @endTime | 0 . . . 1 | dateTime | End time |
| SrcFlow | 0 . . . 1 | srcFlowType | Source Flow as defined in Annex A of A/331 |
| RepairFlow | 0 . . . 1 | rprFlowType | Repair Flow as defined in Annex A of A/331 |

A/331 provides the following additional description of the respective elements and attributed included in Table 2:
S-TSID—Root element of the Service-based Transport Session Instance Description.
@serviceId—A 16-bit unsigned integer value that identifies the ATSC 3.0 service named in the USBD fragment which references this S-TSID fragment. Its value and semantics are identical to that of the serviceId attribute in the USBD fragment.
RS—Container of information for the one or more ROUTE sessions in which the content components of this ATSC 3.0 service are carried.
@bsId—A 16-bit unsigned integer value that identifies the Broadcast Stream within which the content component(s) of this ATSC 3.0 service are carried. When this attribute is absent, the default Broadcast Stream is the one whose PLPs carry SLS fragments for this ATSC 3.0 service. The value of this attribute shall be identical to that of the @bsid in the SLT.
@sIpAddr—The dotted-IPv4 source IP address for this ROUTE session. Absence of this attribute implies that there is only one ROUTE session associated with broadcast delivery of the content component(s) of this ASC 3.0 service, and whose default value shall be the source IP address of the ROUTE session whose LCT channel carries the SLS fragments for this service. This attribute shall be present if this ROUTE session, whose LCT channel carries content component(s) of this service, is not the primary ROUTE session associated with this service.
@dIpAddr—The dotted-IPv4 destination IP address for this ROUTE session. Absence of this attribute implies that there is only one ROUTE session associated with broadcast delivery of the content component(s) of this ATSC 3.0 service, and whose default value shall be the destination IP address of the ROUTE session whose LCT channel carries the SLS fragments for this service. This attribute shall be present if this ROUTE session, whose LCT channel carries content component(s) of this service, is not the primary ROUTE session associated with this service.
@dport—The destination port number associated with the dotted-IPv4 destination IP address for this ROUTE session. Absence of this attribute implies that there is only one ROUTE session associated with broadcast delivery of the content component(s) of this ATSC 3.0 service, and whose default value shall be the destination IP address of the ROUTE session whose LCT channel carries the SLS fragments for this service. This attribute shall be present if this ROUTE session, whose LCT channel carries content component(s) of this service, is not the primary ROUTE session associated with this service.
LS—Container of information for each of the one or more LCT channels that carry content component(s) of the ATSC 3.0 service to which the ROUTE session(s) identified in this 5-TSID are associated.
@tsi—A 32-bit unsigned integer that represents the value of the Transport Session Identifier (TSI) for this LCT channel and whose uniqueness is scoped by its parent ROUTE session.
@bw—A 32-bit unsigned integer which when present, represents the maximum bit-rate required by this LCT channel and associated ROUTE session. It shall be specified by using the Application Specific (AS) bandwidth modifier, at the media level, in RFC 4566 [Internet Engineering Task Force (IETF): Request for Comment (RFC) 4566, “SDP: Session Description Protocol,” Internet Engineering Task Force, Reston, Va., July 2006.]. The AS bandwidth for an LCT channel of the parent ROUTE session shall be the largest value among the sum of the sizes of all packets transmitted during any one second long period of the session, expressed in kilobits. The size of the packet shall be the complete packet, i.e. comprising IP, UDP and ROUTE headers, and the data payload.
@startTime—The start time of the ROUTE session containing this LCT channel, defined in accordance to the time description, i.e. “t=” line in RFC 4566, and representing the “t=<start-time>” value, The only difference from RFC 4566 is in the format of the session start time—i.e., instead of decimal representation of the NTP (Network Time Protocol) time value, in this specification, the session start time is represented by the “dateTime” XML datatype as defined in XSD Datatypes.
@endTime—The end time of the ROUTE session containing this LCT channel, defined in accordance to the time description, i.e. “t=” line in RFC 4566, and representing the “t=<end-time>” value, The only difference from RFC 4566 is in the format of the session end time—i.e., instead of decimal representation of the NTP (Network Time Protocol) time value, in this specification, the session end time is represented by the “dateTime” XML datatype as defined in XSD Datatypes.
SrcFlow—Container of information for each of the one or more Source Flows (as defined in Annex A, Section A.3 of A/331), within its parent LCT channel.
RepairFlow—Container of information for each of the one or Repair Flows (as defined in Annex A, Section A.4 of A/331), within its parent LCT channel.

As illustrated in Table 2, properties common to the LCT channels, and certain properties unique to individual LCT channels, are provided in the S-TSID. For example, @bsid, which may be optionally signaled for each ROUTE session, would be common to each LCT channel and further common to each ROUTE session corresponding to the S-TSID. In some instances a service provider may wish to signal @bsid for all ROUTE sessions at the SLS level. For example, it may be inefficient for a receiver device to store and retrieve a @bsid parsed from the SLT. For example, it may be less than ideal for a receiver device to store a @bsid parsed from the SLT to a channel map and subsequently retrieve @bsid from the channel map.

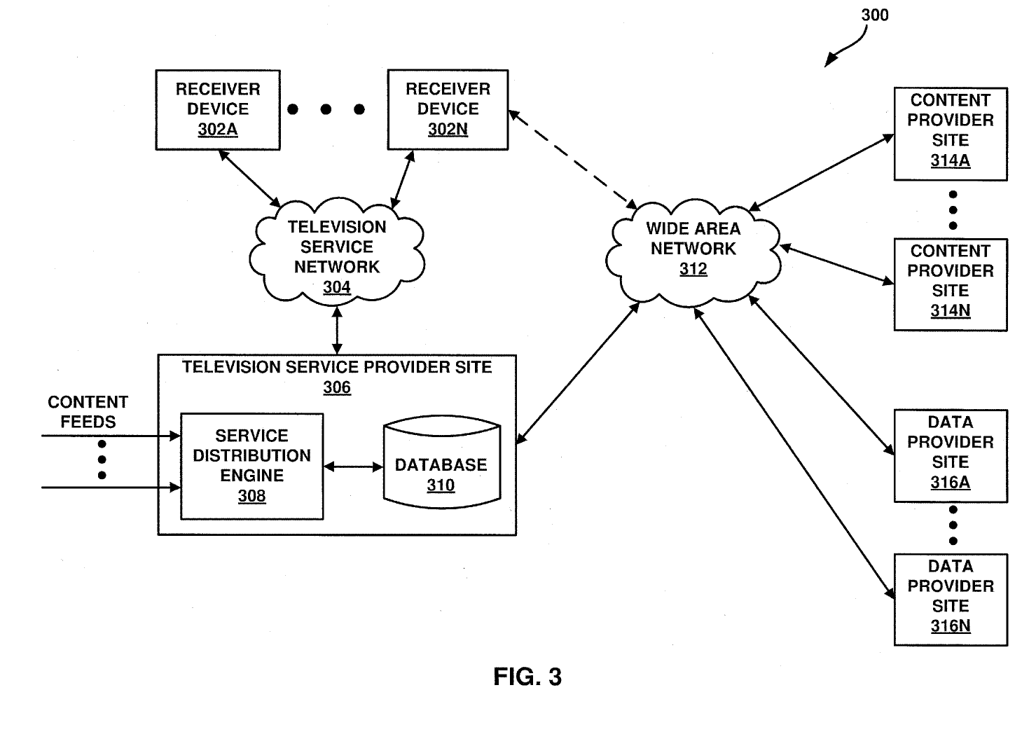

FIG. 3 is a block diagram illustrating an example of a system that may implement one or more techniques described in this disclosure. System 300 may be configured to communicate data in accordance with the techniques described herein. In the example illustrated in FIG. 3, system 300 includes one or more receiver devices 302A-302N, television service network 304, television service provider site 306, wide area network 312, one or more content provider sites 314A-314N, and one or more data provider sites 316A-316N. System 300 may include software modules. Software modules may be stored in a memory and executed by a processor. System 300 may include one or more processors and a plurality of internal and/or external memory devices. Examples of memory devices include file servers, file transfer protocol (FTP) servers, network attached storage (NAS) devices, local disk drives, or any other type of device or storage medium capable of storing data. Storage media may include Blu-ray discs, DVDs, CD-ROMs, magnetic disks, flash memory, or any other suitable digital storage media. When the techniques described herein are implemented partially in software, a device may store instructions for the software in a suitable, non-transitory computer-readable medium and execute the instructions in hardware using one or more processors.

System 300 represents an example of a system that may be configured to allow digital media content, such as, for example, a movie, a live sporting event, etc., and data and applications and media presentations associated therewith (e.g., emergency alerts), to be distributed to and accessed by a plurality of computing devices, such as receiver devices 302A-302N. In the example illustrated in FIG. 3, receiver devices 302A-302N may include any device configured to receive data from television service provider site 306. For example, receiver devices 302A-302N may be equipped for wired and/or wireless communications and may be configured to receive services through one or more data channels and may include televisions, including so-called smart televisions, set top boxes, and digital video recorders. Further, receiver devices 302A-302N may include desktop, laptop, or tablet computers, gaming consoles, mobile devices, including, for example, “smart” phones, cellular telephones, and personal gaming devices configured to receive data from television service provider site 306. It should be noted that although system 300 is illustrated as having distinct sites, such an illustration is for descriptive purposes and does not limit system 300 to a particular physical architecture. Functions of system 300 and sites included therein may be realized using any combination of hardware, firmware and/or software implementations.

Television service network 304 is an example of a network configured to enable digital media content, which may include television services, to be distributed. For example, television service network 304 may include public over-the-air television networks, public or subscription-based satellite television service provider networks, and public or subscription-based cable television provider networks and/or over the top or Internet service providers. It should be noted that although in some examples television service network 304 may primarily be used to enable television services to be provided, television service network 304 may also enable other types of data and services to be provided according to any combination of the telecommunication protocols described herein. Further, it should be noted that in some examples, television service network 304 may enable two-way communications between television service provider site 306 and one or more of receiver devices 302A-302N. Television service network 304 may comprise any combination of wireless and/or wired communication media. Television service network 304 may include coaxial cables, fiber optic cables, twisted pair cables, wireless transmitters and receivers, routers, switches, repeaters, base stations, or any other equipment that may be useful to facilitate communications between various devices and sites. Television service network 304 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, HbbTV standards, W3C standards, and UPnP standards.

Referring again to FIG. 3, television service provider site 306 may be configured to distribute television service via television service network 304. For example, television service provider site 306 may include one or more broadcast stations, a cable television provider, or a satellite television provider, or an Internet-based television provider. In the example illustrated in FIG. 3, television service provider site 306 includes service distribution engine 308 and database 310. Service distribution engine 308 may be configured to receive data, including, for example, multimedia content, interactive applications, and messages, including emergency alert messages, and distribute data to receiver devices 302A-302N through television service network 304. For example, service distribution engine 308 may be configured to transmit television services according to aspects of the one or more of the transmission standards described above (e.g., an ATSC standard). In one example, service distribution engine 308 may be configured to receive data through one or more sources. For example, television service provider site 306 may be configured to receive a transmission including television programming through a satellite uplink/downlink. Further, as illustrated in FIG. 3, television service provider site 306 may be in communication with wide area network 312 and may be configured to receive data from content provider sites 314A-314N and further receive data from data provider sites 316A-316N. It should be noted that in some examples, television service provider site 306 may include a television studio and content may originate therefrom.

Database 310 may include storage devices configured to store data including, for example, multimedia content and data associated therewith, including for example, descriptive data and executable interactive applications. For example, a sporting event may be associated with an interactive application that provides statistical updates. Data associated with multimedia content may be formatted according to a defined data format, such as, for example, HTML, Dynamic HTML, XML, and JavaScript Object Notation (JSON), and may include URLs and URIs enabling receiver devices 302A-302N to access data, e.g., from one of data provider sites 316A-316N. In some examples, television service provider site 306 may be configured to provide access to stored multimedia content and distribute multimedia content to one or more of receiver devices 302A-302N through television service network 304. For example, multimedia content (e.g., music, movies, and television (TV) shows) stored in database 310 may be provided to a user via television service network 304 on a so-called on demand basis.

Wide area network 312 may include a packet based network and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3^{rd} Generation Partnership Project (3GPP) standards, European Telecommunications Standards Institute (ETSI) standards, European standards (EN), IP standards, Wireless Application Protocol (WAP) standards, and Institute of Electrical and Electronics Engineers (IEEE) standards, such as, for example, one or more of the IEEE 802 standards (e.g., Wi-Fi). Wide area network 312 may comprise any combination of wireless and/or wired communication media. Wide area network 312 may include coaxial cables, fiber optic cables, twisted pair cables, Ethernet cables, wireless transmitters and receivers, routers, switches, repeaters, base stations, or any other equipment that may be useful to facilitate communications between various devices and sites. In one example, wide area network 316 may include the Internet.

Referring again to FIG. 3, content provider sites 314A-314N represent examples of sites that may provide multimedia content to television service provider site 306 and/or receiver devices 302A-302N. For example, a content provider site may include a studio having one or more studio content servers configured to provide multimedia files and/or streams to television service provider site 306. In one example, content provider sites 314A-314N may be configured to provide multimedia content using the IP suite. For example, a content provider site may be configured to provide multimedia content to a receiver device according to Real Time Streaming Protocol (RTSP), HTTP, or the like.

Data provider sites 316A-316N may be configured to provide data, including hypertext based content, and the like, to one or more of receiver devices 302A-302N and/or television service provider site 306 through wide area network 312. A data provider site 316A-316N may include one or more web servers. Data provided by data provider site 316A-316N may be defined according to data formats, such as, for example, HTML, Dynamic HTML, XML, and JSON. An example of a data provider site includes the United States Patent and Trademark Office website. It should be noted that in some examples, data provided by data provider sites 316A-316N may be utilized for so-called second screen applications. For example, companion device(s) in communication with a receiver device may display a website in conjunction with television programming being presented on the receiver device. It should be noted that data provided by data provider sites 316A-316N may include audio and video content.

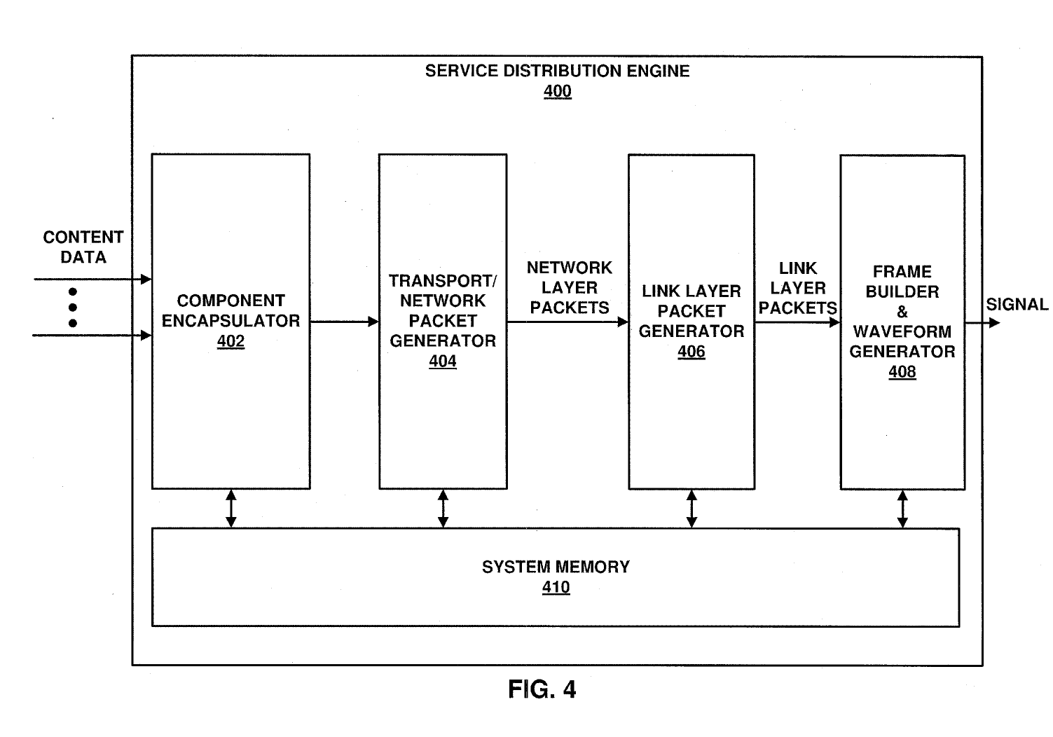

As described above, service distribution engine 308 may be configured to receive data, including, for example, multimedia content, interactive applications, and messages, and distribute data to receiver devices 302A-302N through television service network 304. FIG. 4 is a block diagram illustrating an example of a service distribution engine that may implement one or more techniques of this disclosure. Service distribution engine 400 may be configured to receive data and output a signal representing that data for distribution over a communication network, e.g., television service network 304. For example, service distribution engine 400 may be configured to receive one or more sets of data and output a signal that may be transmitted using a single radio frequency band (e.g., a 6 MHz channel, an 8 MHz channel, etc.) or a bonded channel (e.g., two separate 6 MHz channels). As described above, the proposed ATSC 3.0 suite of standards refers to the abstraction for an RF Channel as a Broadcast Stream.

As illustrated in FIG. 4, service distribution engine 400 includes component encapsulator 402, transport/network packet generator 404, link layer packet generator 406, frame builder and waveform generator 408, and system memory 410. Each of component encapsulator 402, transport/network packet generator 404, link layer packet generator 406, frame builder and waveform generator 408, and system memory 410 may be interconnected (physically, communicatively, and/or operatively) for intercomponent communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although service distribution engine 400 is illustrated as having distinct functional blocks, such an illustration is for descriptive purposes and does not limit service distribution engine 400 to a particular hardware architecture. Functions of service distribution engine 400 may be realized using any combination of hardware, firmware and/or software implementations.

System memory 410 may be described as a non-transitory or tangible computer-readable storage medium. In some examples, system memory 410 may provide temporary and/or long-term storage. In some examples, system memory 410 or portions thereof may be described as non-volatile memory and in other examples portions of system memory 410 may be described as volatile memory. Examples of volatile memories include random access memories (RAM), dynamic random access memories (DRAM), and static random access memories (SRAM). Examples of non-volatile memories include magnetic hard discs, optical discs, floppy discs, flash memories, or forms of electrically programmable memories (EPROM) or electrically erasable and programmable (EEPROM) memories. System memory 410 may be configured to store information that may be used by service distribution engine 400 during operation. It should be noted that system memory 410 may include individual memory elements included within each of component encapsulator 402, transport/network packet generator 404, link layer packet generator 406, and frame builder and waveform generator 408. For example, system memory 410 may include one or more buffers (e.g., First-in First-out (FIFO) buffers) configured to store data for processing by a component of service distribution engine 400.

Component encapsulator 402 may be configured to receive one or more components of a service and encapsulate the one or more components according to a defined data structure. For example, component encapsulator 402 may be configured to receive one or more media components and generate a package based on MMTP. Further, component encapsulator 402 may be configured to receive one or more media components and generate media presentation based on DASH. It should be noted that in some examples, component encapsulator 402 may be configured to generate service layer signaling data. Transport/network packet generator 404 may be configured to receive a transport package and encapsulate the transport package into corresponding transport layer packets (e.g., UDP, Transport Control Protocol (TCP), etc.) and network layer packets (e.g., Ipv4, Ipv6, compressed IP packets, etc.). Link layer packet generator 406 may be configured to receive network packets and generate packets according to a defined link layer packet structure (e.g., an ATSC 3.0 link layer packet structure).

Frame builder and waveform generator 408 may be configured to receive one or more link layer packets and output symbols (e.g., OFDM symbols) arranged in a frame structure. As described above, a frame may include one or more PLPs may be referred to as a physical layer frame (PHY-Layer frame). In one example, a frame structure may include a bootstrap, a preamble, and a data payload including one or more PLPs. A bootstrap may act as a universal entry point for a waveform. A preamble may include so-called Layer-1 signaling (L1-signaling). L1-signaling may provide the necessary information to configure physical layer parameters. Frame builder and waveform generator 408 may be configured to produce a signal for transmission within one or more of types of RF channels: a single 6 MHz channel, a single 7 MHz channel, single 8 MHz channel, a single 11 MHz channel, and bonded channels including any two or more separate single channels (e.g., a 14 MHz channel including a 6 MHz channel and a 8 MHz channel). Frame builder and waveform generator 408 may be configured to insert pilots and reserved tones for channel estimation and/or synchronization. In one example, pilots and reserved tones may be defined according to an OFDM symbol and sub-carrier frequency map. Frame builder and waveform generator 408 may be configured to generate an OFDM waveform by mapping OFDM symbols to sub-carriers. It should be noted that in some examples, frame builder and waveform generator 408 may be configured to support layer division multiplexing. Layer division multiplexing may refer to super-imposing multiple layers of data on the same RF channel (e.g., a 6 MHz channel). Typically, an upper layer refers to a core (e.g., more robust) layer supporting a primary service and a lower layer refers to a high data rate layer supporting enhanced services. For example, an upper layer could support basic High Definition video content and a lower layer could support enhanced Ultra-High Definition video content.

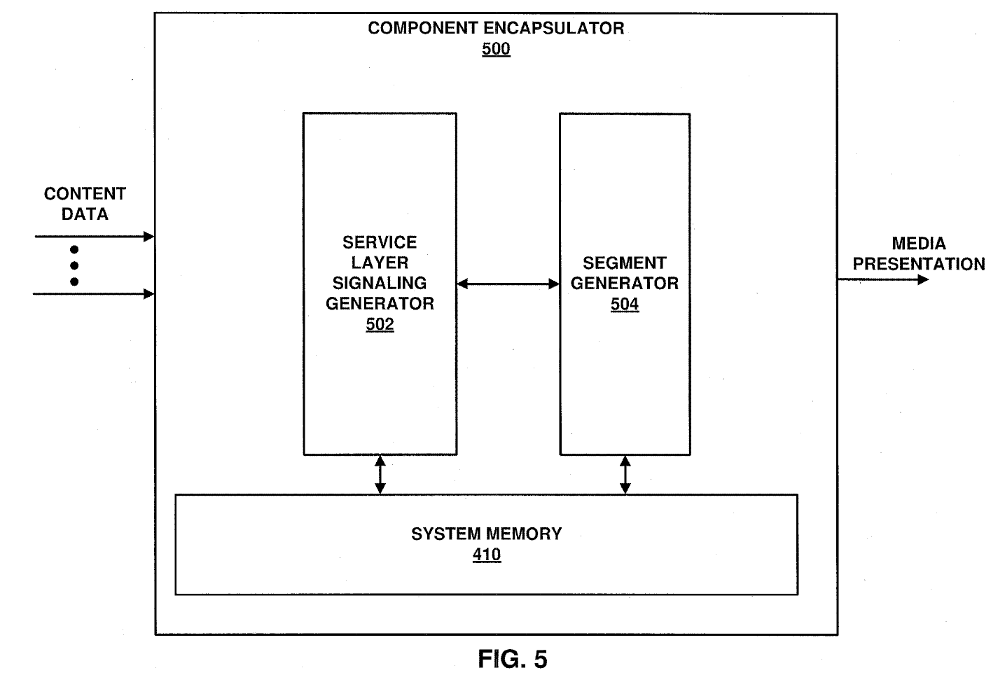

As described above, component encapsulator 402 may be configured to receive one or more media components and generate media presentation based on DASH. FIG. 5 is a block diagram illustrating an example of a component encapsulator that may implement one or more techniques of this disclosure. Component encapsulator 500 may be configured to generate a media presentation according to the techniques described herein. In the example illustrated in FIG. 5, functional blocks of component encapsulator 500 correspond to functional blocks for generating a media presentation (e.g., a DASH media presentation). As illustrated in FIG. 5, component encapsulator 500 includes service layer signaling generator 502 and segment generator 504. Each of service layer signaling generator 502 and segment generator 504 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although component encapsulator 500 is illustrated as having distinct functional blocks, such an illustration is for descriptive purposes and does not limit component encapsulator 500 to a particular hardware architecture. Functions of component encapsulator 500 may be realized using any combination of hardware, firmware and/or software implementations.

Segment generator 504 may be configured to receive media components and generate one or more segments for inclusion in a media presentation. Service layer signaling generator 502 may be configured to generate metadata fragments (e.g., S-TSID, USBD, and/or MPD). It should be noted that in some examples, a service distribution engine (e.g., service distribution engine 308 or service distribution engine 400) or specific components thereof may be configured to generate metadata fragments according to the techniques described herein. As such, description of signaling messages, including metadata fragments, with respect to service layer signaling generator 502 should not be construed to limit the techniques described herein. Thus, component encapsulator 402 and/or service distribution engine 400 may be configured to generate metadata fragments and/or similar signaling data according to one or more of the techniques described herein.

As described above, with respect to Table 1, the ROUTE/DASH USBD fragment in A/331 implicitly requires that at least one content component of an ATSC 3.0 service be delivered via a broadcast path. Table 3 provides an example of semantics of a ROUTE/DASH USBD fragment that may enable a service provider to include all content components of an ATSC 3.0 service via a broadband path, while signaling bootstrap information using a broadcast path according to one or more techniques of this disclosure.

TABLE 3

| Element or Attribute Name | | Use | Data Type | Description |
|---|---|---|---|---|
| bundleDescription | | | | Root element of the User Service Bundle |
| | | | | Description. |
| | userServiceDescription | | | A single instance of an ATSC 3.0 Service. |

| @globalServiceID | 1 | anyURI | A globally unique URI that identifies the |
|---|---|---|---|
| | | | ATSC 3.0 Service. |
| @serviceId | 1 | unsignedShort | Reference to corresponding service entry in |
| | | | the SLT. |
| @serviceStatus | 0 . . . 1 | boolean | Specify the status of this service as active or |
| | | | inactive. |
| @fullMPDUri | 1 | anyURI | Reference to an MPD fragment which |
| | | | contains descriptions for contents |
| | | | components of the ATSC 3.0 Service |
| | | | delivered over broadcast and optionally, also |
| | | | over broadband. |
| @sTSIDUri | 1 | anyURI | Reference to the S-TSID fragment which |
| | | | provides access related parameters for the |
| | | | Transport sessions carrying contents of this |
| | | | ATSC 3.0 Service. |
| name | 0 . . . N | string | Name of the ATSC 3.0 service. |

| | | | |
|---|---|---|---|
| @lang | 1 | language | Language of the ATSC 3.0 service name. |

| serviceLanguage | 0 . . . N | language | Available languages of the ATSC 3.0 |
|---|---|---|---|
| | | | service. |
| capabilityCode | 0 . . . 1 | string | Representation of the capabilities and |
| | | | capability groups, required in the receiver, to |
| | | | be able to create a meaningful presentation of |
| | | | the content of this ATSC service. |
| deliveryMethod | 1 . . . N | | Container of transport related information |

| | | pertaining to the contents of the service over |
|---|---|---|
| | | broadcast or broadband modes of access. |
| broadcastAppService | 0 . . . N | A DASH Representation delivered over |

| | | | broadcast, containing the corresponding |
|---|---|---|---|
| | | | media component(s) belonging to the ATSC |
| | | | 3.0 Service. |
| basePattern | 1 . . . N | string | A character pattern for use by the ATSC |

| | | receiver to match against any portion of the |
|---|---|---|
| | | Segment URL used by the DASH client to |
| | | request Media Segments of a parent |
| | | Representation. |
| unicastAppService | 0 . . . N | A DASH Representation delivered over |

| | | | broadband, containing the constituent media |
|---|---|---|---|
| | | | content component(s) belonging to the ATSC |
| | | | 3.0 Service. |
| basePattern | 1 . . . N | string | A character pattern for use by the ATSC |

receiver to match against any portion of the
Segment URL used by the DASH client to
request Media Segments of a parent
Representation.

In Table 3, each of bundleDescription, UserServiceDescription, @globalServiceID, @serviceId, @serviceStatus, @fullMPDUri, @sTSIDUri, name, @lang, serviceLanguage, deliveryMethod, basePattern (under broadcastAppService), unicastAppService, basePattern (under unicastAppService) may be based on the description provided above with respect to Tablet. As illustrated in Table 3, the cardinality of broadcastAppService is 0 . . . N and as such broadcastAppService is not required to be present in the ROUTE/DASH USBD. It should be noted that in some examples, that the ROUTE/DASH USBD semantics in Table 3 may require the presence of at least one of broadcastAppService or unicastAppService inside each deliveryMethod element. Thus, it may be required that at least one of broadcastAppService or unicastAppService elements shall be present inside each deliveryMethod element. In another example cardinality of deliveryMethod element may be changed from 1 . . . N to 0 . . . N. Thus, a USBD could be signalled without a deliveryMethod element. In this manner, service distribution engine 400 represents an example of a device configured to signal a syntax element identifying a data channel corresponding to respective media delivery sessions including media components forming the one or more services using service layer signaling.

As described above with respect to Table 2, the S-TSID fragment as provided in A/331 enables a service provider to only optionally signal the @bsid for each ROUTE session and such signaling may be less than ideal. Table 4 provides an example of semantics of a S-TSID fragment that may enables a service provider to signal the @bsid for each ROUTE session using a single instance of @bsid in the S-TSID according to one or more techniques of this disclosure.

TABLE 4

| Element and Attribute Names | | Use | Data Type | Description |
|---|---|---|---|---|
| S-TSID | | | | Service Transport Session Instance |
| | | | | Description |
| | @bsid | 1 | unsignedShort | Identifier of the Broadcast Stream within |
| | | | | which the content component(s) of the ATSC |
| | | | | 3.0 service are carried. Its value shall be |
| | | | | identical to that of the @bsid in the SLT. |
| | @serviceId | 0 . . . 1 | unsignedShort | Reference to corresponding service element |
| | | | | in the USD. The value of this attribute shall |
| | | | | reference a service with a corresponding |
| | | | | value of ServiceId. |
| | RS | 1 . . . N | | ROUTE session |

| @sIpAddr | 0 . . . 1 | string | Source IP address (default: current ROUTE |
|---|---|---|---|
| | | | session's source IP address) (M for non- |
| | | | primary session) |
| @dIpAddr | 0 . . . 1 | string | Destination IP address (default: current |
| | | | ROUTE session's destination IP address) (M |
| | | | for non-primary session) |
| @dport | 0 . . . 1 | unsignedShort | Destination port (default: current ROUTE |
| | | | session's destination port) (M for non- |
| | | | primary session) |
| LS | 1 . . . N | | LCT channel |

| | | | |
|---|---|---|---|
| @tsi | 1 | unsignedInt | TSI value |
| @bw | 0 . . . 1 | unsignedInt | Maximum bandwidth |
| @startTime | 0 . . . 1 | dateTime | Start time |
| @endTime | 0 . . . 1 | dateTime | End time |
| SrcFlow | 0 . . . 1 | srcFlowType | Source Flow as defined in Annex A of A/331 |
| RepairFlow | 0 . . . 1 | rprFlowType | Repair Flow as defined in Annex A of A/331 |

In Table 4, each of S-TSID, @serviceId, RS, @sIpAddr, @dIpAddr, @dport, LS, @tsi, @bw, @startTime, @endTime, SrcFlow, and RepairFlow may be based on the descriptions provided above with respect to Table 2. The semantics of @bsid in Table 4, in some examples, may be as follows:
@bsId—A 16-bit unsigned integer value that identifies the Broadcast Stream within which the content component(s) of this ATSC 3.0 service are carried. The value of this attribute shall be identical to that of the @bsid in the SLT.

It should be noted with respect to Table 4 that @bsid is a child attribute of S-TSID element instead of being an attribute of RS elements. In this manner, a service provider may be enabled to signal only one @bsid attribute to cover all ROUTE sessions signaled in a S-TSID. Further, it should be noted that with respect to the example illustrated in Table 4, the cardinality of @bsid is 1, i.e., @bsid is required. Requiring @bsid in the S-TSID may allow the higher layers parsing the S-TSID XML fragment to efficiently determine the value of Broadcast Stream identifier. That is, for example, a high layer application may be able to determine the value of Broadcast Stream identifier the value of Broadcast Stream identifier without requiring knowledge of the SLT or about PLPs on which SLS fragments are signaled. It should be noted that in another example the @bsid signalled as shown in Table 4 may have a Use (or cardinality) of 0 . . . 1. Thus, @bsid may be optionally signalled. In one example, when @bsid is not signalled it may be inferred to be equal to the Broadcast Stream identifier value of default Broadcast stream whose PLPs carry SLS fragments for this ATSC 3.0 service. In another example, instead of @bsid attribute in Table 4, @globalServiceID attribute may be signalled as a child attribute of S-TSID element. Example semantics of @globalServiceID may be as follows:
@globalServiceID—The globally unique URI value representing the identifier of the ATSC 3.0 service named in the USBD fragment which references this S-TSID fragment. Its value and semantics are identical to that of the @globalServiceID attribute in the USBD fragment.

In yet another example the @bsid attribute may not be signaled in S-TSID (in Table 4). In this case, the value of @bsid for each ROUTE session may be inferred to be equal to the value of the @bsid attribute in the SLT which carries a matching Service element with the value of SLT.Service.serviceId equal to @serviceID in Table 4. In this notation a.b.c indicates that element c is a child element of element b which is a child element of element a.

As described above, examples of services include: a “linear audio/video service” consisting of one or more continuous video components, one or more continuous audio components, and one or more closed caption components, and optionally including app-based features; a “linear audio-only service” consisting of one or more continuous audio components and one or more closed caption components, and optionally including app-based features; and an “app-based service” consisting entirely of app-based features. With respect to a live event or the like (e.g., a sporting event) a service creator may create multiple components and a service provider may define and distribute multiple services using the components. For example, with respect to a sporting event, a service creator may create a video component, an audio component, a closed caption component, and an application. The service creator may transmit the components to a service provider (e.g., a national television network may transmit the components to a local affiliate). In this case, in one example, using the four components the service provider may create three distinct services, i.e., a linear audio/video service consisting of the video component, the audio component, the close caption component, and the application (e.g., serviceId equal to 500); a linear audio-only service consisting of the audio component, the close caption component, and the application (e.g., serviceId equal to 501); and an app-based service consisting of the application (e.g., serviceId equal to 502). In some instances, it may be useful for a receiver device to determine if a component of a service identified by a service identifier, for example, serviceId1, is associated with another service identified by another service identifier, for example, serviceId2.

Table 5 provides an example of semantics of a S-TSID fragment that may enables a service provider to signal the whether a service component for a ROUTE session is associated with another distinct service.

TABLE 5

| Element and Attribute Names | | Use | Data Type | Description |
|---|---|---|---|---|
| S-TSID | | | | Service Transport Session Instance |
| | | | | Description |
| | @serviceId | 0 . . . 1 | unsignedShort | Reference to corresponding service element |
| | | | | in the USBD. |
| | RS | 1 . . . N | | ROUTE session |

| @bsid | 0 . . . 1 | unsignedShort | Identifier of the Broadcast Stream within |
|---|---|---|---|
| | | | which the content component(s) of this ATSC |
| | | | 3.0 service are carried. |
| @serviceId | 0 . . . 1 | unsignedShort | Integer number that identifies the Service |
| | | | within @bsid corresponding to the content |
| | | | component |
| @sIpAddr | 0 . . . 1 | string | Source IP address of this ROUTE session; |
| | | | mandatory for ROUTE session other than |
| | | | session carrying SLS (session signaled in |
| | | | SLT); defaults to session carrying SLS. |
| @dIpAddr | 0 . . . 1 | string | Destination IP address of this ROUTE |
| | | | session; mandatory for ROUTE session other |
| | | | than session carrying SLS (session signaled in |
| | | | SLT); defaults to session carrying SLS. |
| @dport | 0 . . . 1 | unsignedShort | Destination port of this ROUTE session; |
| | | | mandatory for ROUTE session other than |
| | | | session carrying SLS (session signaled in |
| | | | SLT); defaults to session carrying SLS. |
| LS | 1 . . . N | | LCT channel |

| | | | |
|---|---|---|---|
| @tsi | 1 | unsignedInt | TSI value |
| @bw | 0 . . . 1 | unsignedInt | Maximum bandwidth |
| @startTime | 0 . . . 1 | dateTime | Start time |
| @endTime | 0 . . . 1 | dateTime | End time |
| SrcFlow | 0 . . . 1 | srcFlowType | Source Flow as defined in Annex A of A/331 |
| RepairFlow | 0 . . . 1 | rprFlowType | Repair Flow as defined in Annex A of A/331 |

In Table 5, each of S-TSID, the first instance of @serviceId, RS, @sIpAddr, @dIpAddr, @dport, LS, @tsi, @bw, @startTime, @endTime, SrcFlow, and RepairFlow may be based on the descriptions provided above with respect to Table 2 and/or Table 4. The semantics of RS, @bsid, the second instance of @serviceId, @sIpAddr, @dIpAddr, @dport, LS, SrcFlow, and/or RepairFlow in Table 5, in some examples, may be as follows:
RS—A complex element whose subordinate elements and attributes contain information about the one or more ROUTE sessions in which the content components of this ATSC 3.0 service are carried.
@bsid—A 16-bit unsigned integer value that identifies the Broadcast Stream within which the content component(s) of this ATSC 3.0 service are carried. When this attribute is absent, the default Broadcast Stream shall be the one whose PLPs carry SLS fragments for this ATSC 3.0 service. This attribute shall be present when the component is on a different RF Channel and single tuner receivers may ignore it.
@serviceId—A 16-bit unsigned integer value that shall identify the ATSC 3.0 service within the broadcast stream identified by the @bsid corresponding to the content component. This attribute shall be present when the component is on a different RF Channel

In another example, the semantics of @serviceId may be written as follows:
@serviceId—A 16-bit unsigned integer value that shall identify the ATSC 3.0 service within the broadcast stream identified by the @bsid corresponding to the content component. This attribute shall be present when the component is on a different @bsid than the current service's bsid value.
@sIpAddr—A dotted-IPv4 source IP address whose value shall represent the source IP address for this ROUTE session. When this attribute is absent, the default value shall be the source IP address of the ROUTE session whose LCT channel carries the SLS fragments for this service. This attribute shall be present if this ROUTE session, whose LCT channel carries content component(s) of this service, is not the ROUTE session/LCT channel carrying the SLS fragments.
@dIpAddr—A dotted-IPv4 destination IP address whose value shall represent the destination IP address for this ROUTE session. When this attribute is absent, the default value shall be the destination IP address of the ROUTE session whose LCT channel carries the SLS fragments for this service. This attribute shall be present if this ROUTE session, whose LCT channel carries content component(s) of this service, is not the ROUTE session/LCT channel carrying the SLS fragments.
@dport—A destination port number whose value shall be associated with the dotted-IPv4 destination IP address for this ROUTE session. When this attribute is absent, the default value shall be the destination port number of the ROUTE session whose LCT channel carries the SLS fragments for this service. This attribute shall be present if this ROUTE session, whose LCT channel carries content component(s) of this service, is not the ROUTE session/LCT channel carrying the SLS fragments.
LS—A complex element whose subordinate elements and attributes contain information about each of the one or more LCT channels that carry content component(s) of the ATSC 3.0 service to which the ROUTE session(s) identified in this S-TSID are associated.
SrcFlow—A complex element whose subordinate elements and attributes contain information about each of the one or more Source Flows (as defined in Annex A, Section A.3 of A/331), within its parent LCT channel.
RepairFlow—A complex element whose subordinate elements and attributes contain information about the Repair Flow (as defined in Annex A, Section A.4 of A/331), if present, within its parent LCT channel.

It should be noted that when comparing the semantics in Table 5 to the semantics in

Table 2 and Table 4, the example semantics in Table 5 removes the following the constraint: The value of this @bsid attribute shall be identical to that of the @bsid in the SLT. Thus, the @bsid value in the example illustrated in Table 5 may be different than the @bsid value in SLT for this service.

With respect to the example sporting event described above, an instance of a S-TSID fragment based on the semantics provided in Table 5 may have S-TSID@serviceId having a value of 500 and S-TSID.RS@serviceId having respective values of 501 and 502 for the linear audio/video service. The example semantics of a S-TSID fragment in Table 5 may be useful when a user of a receiver device wishes to switch from one service to another. For example, a user watching a sporting event may wish to switch from the linear audio/video service to the linear audio only service. In this case, the example semantics in Table 5 may enable a receiver device to switch services without being required to separately retrieve and parse an instance of a S-TSID fragment corresponding to the linear audio only service. Additionally, in another example case, if one of the components in another Broadcast Stream is a non-real-time component, (e.g. a file) and has already been downloaded and cached, then that component can be used directly from the cache when it is referred in this service's S-TSID as via attribute S-TSID.RS@serviceId. Such caching may increase system efficiency.

With respect to the description above, it should be noted that following notation may be used:
An XML element EET has an attribute ATTRIB. The XML element EET also has a sub-element (also referred to as a child element) EET1. The element EET1 has an attribute ATTRIB1. Then the following notation may be used:
The attribute ATTRIB of element EET may be denoted as EET@ATTRIB. The sub-element (also referred to as a child element) EET1 of element EET may be denoted as EET.EET1.
The attribute ATTRIB1 of sub-element (also referred to as a child element) EET1 of element EET may be denoted as EET.EET1@ATTRIB1.

Further, with respect to Table 3, 4, and 5, the following variations may apply:
Different data types may be used for an element compared to those shown above. For example instead of unsignedByte data type unsignedShort data type may be used. In another example instead of unsigned Byte data type a String data type may be used.
Instead of signalling a syntax as an attribute it may be signalled as an element. Instead of signalling a syntax as an element it may be signalled as an attribute.
Cardinality of an element and/or attribute may be changed. For example For example cardinality may be changed from “1” to “1 . . . N” or cardinality may be changed from “1” to “0 . . . N” or cardinality may be changed from “1” to “0 . . . 1” or cardinality may be changed from “0 . . . 1” to “0 . . . N” or cardinality may be changed from “0 . . . N” to “0 . . . 1”.
An element and/or attribute may be made required when it is shown above as optional. An element and/or attribute may be made optional when it is shown above as required.
Some child elements may instead be signalled as parent elements or they may be signalled as child elements of another child elements.

In this manner, service distribution engine 400 represents an example of a device configured to signal a data channel information using a service layer signaling mechanism.

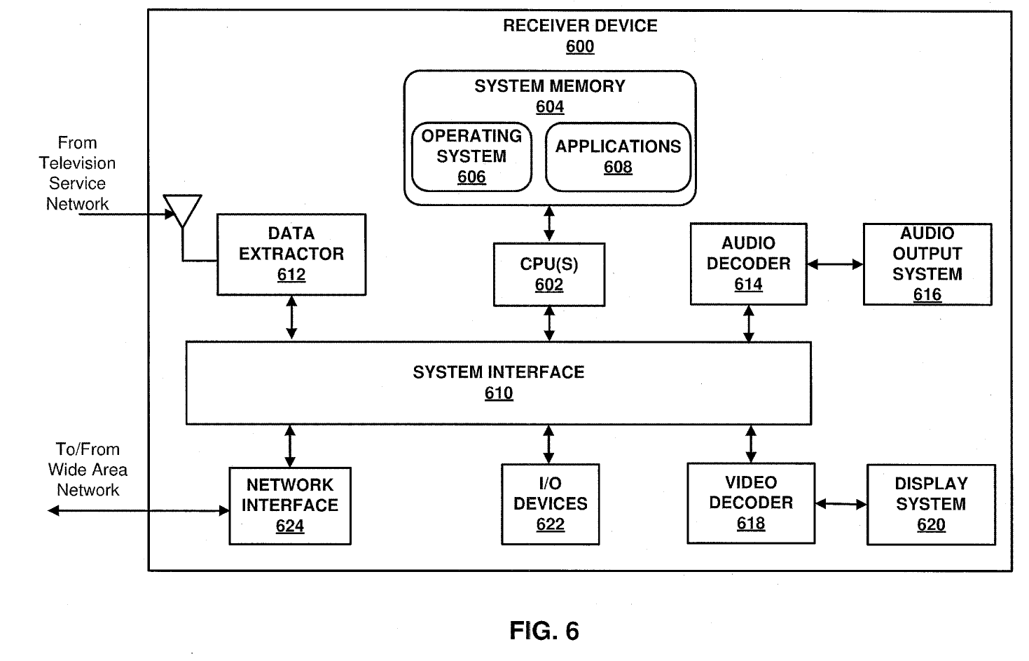

FIG. 6 is a block diagram illustrating an example of a receiver device that may implement one or more techniques of this disclosure. That is, receiver device 600 may be configured to parse a signal based on the semantics described above with respect to one or more of the tables described above. Further, receiver device 600 may be configured to parse information associated with a ROUTE session. Receiver device 600 is an example of a computing device that may be configured to receive data from a communications network via one or more types of data channels and allow a user to access multimedia content. In the example illustrated in FIG. 6, receiver device 600 is configured to receive data via a television network, such as, for example, television service network 304 described above. Further, in the example illustrated in FIG. 6, receiver device 600 is configured to send and receive data via a wide area network. It should be noted that in other examples, receiver device 600 may be configured to simply receive data through a television service network 304. The techniques described herein may be utilized by devices configured to communicate using any and all combinations of communications networks.

As illustrated in FIG. 6, receiver device 600 includes central processing unit(s) 602, system memory 604, system interface 610, data extractor 612, audio decoder 614, audio output system 616, video decoder 618, display system 620, I/O device(s) 622, and network interface 624. As illustrated in FIG. 6, system memory 604 includes operating system 606 and applications 608. Each of central processing unit(s) 602, system memory 604, system interface 610, data extractor 612, audio decoder 614, audio output system 616, video decoder 618, display system 620, I/O device(s) 622, and network interface 624 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although receiver device 600 is illustrated as having distinct functional blocks, such an illustration is for descriptive purposes and does not limit receiver device 600 to a particular hardware architecture. Functions of receiver device 600 may be realized using any combination of hardware, firmware and/or software implementations.

CPU(s) 602 may be configured to implement functionality and/or process instructions for execution in receiver device 600. CPU(s) 602 may include single and/or multi-core central processing units. CPU(s) 602 may be capable of retrieving and processing instructions, code, and/or data structures for implementing one or more of the techniques described herein. Instructions may be stored on a computer readable medium, such as system memory 604.

System memory 604 may be described as a non-transitory or tangible computer-readable storage medium. In some examples, system memory 604 may provide temporary and/or long-term storage. In some examples, system memory 604 or portions thereof may be described as non-volatile memory and in other examples portions of system memory 604 may be described as volatile memory. System memory 604 may be configured to store information that may be used by receiver device 600 during operation. System memory 704 may be used to store program instructions for execution by CPU(s) 602 and may be used by programs running on receiver device 600 to temporarily store information during program execution. Further, in the example where receiver device 600 is included as part of a digital video recorder, system memory 604 may be configured to store numerous video files.

Applications 608 may include applications implemented within or executed by receiver device 600 and may be implemented or contained within, operable by, executed by, and/or be operatively/communicatively coupled to components of receiver device 600. Applications 608 may include instructions that may cause CPU(s) 602 of receiver device 600 to perform particular functions. Applications 608 may include algorithms which are expressed in computer programming statements, such as, for-loops, while-loops, if-statements, do-loops, etc. Applications 608 may be developed using a specified programming language. Examples of programming languages include, Java™, Jini™, C, C++, Objective C, Swift, Perl, Python, PhP, UNIX Shell, Visual Basic, and Visual Basic Script. In the example where receiver device 600 includes a smart television, applications may be developed by a television manufacturer or a broadcaster. As illustrated in FIG. 6, applications 608 may execute in conjunction with operating system 606. That is, operating system 606 may be configured to facilitate the interaction of applications 608 with CPUs(s) 602, and other hardware components of receiver device 600. Operating system 606 may be an operating system designed to be installed on set-top boxes, digital video recorders, televisions, and the like. It should be noted that techniques described herein may be utilized by devices configured to operate using any and all combinations of software architectures.

System interface 610 may be configured to enable communications between components of receiver device 600. In one example, system interface 610 comprises structures that enable data to be transferred from one peer device to another peer device or to a storage medium. For example, system interface 610 may include a chipset supporting Accelerated Graphics Port (AGP) based protocols, Peripheral Component Interconnect (PCI) bus based protocols, such as, for example, the PCI Express™ (PCIe) bus specification, which is maintained by the Peripheral Component Interconnect Special Interest Group, or any other form of structure that may be used to interconnect peer devices (e.g., proprietary bus protocols).

As described above, receiver device 600 is configured to receive and, optionally, send data via a television service network. As described above, a television service network may operate according to a telecommunications standard. A telecommunications standard may define communication properties (e.g., protocol layers), such as, for example, physical signaling, addressing, channel access control, packet properties, and data processing. In the example illustrated in FIG. 6, data extractor 612 may be configured to extract video, audio, and data from a signal. A signal may be defined according to, for example, aspects DVB standards, ATSC standards, ISDB standards, DTMB standards, DMB standards, and DOCSIS standards.

Data extractor 612 may be configured to extract video, audio, and data, from a signal generated by service distribution engine 400 described above. That is, data extractor 612 may operate in a reciprocal manner to service distribution engine 400. Further, data extractor 612 may be configured to parse link layer packets based on any combination of one or more of the structures described above.

Data packets may be processed by CPU(s) 602, audio decoder 614, and video decoder 618. Audio decoder 614 may be configured to receive and process audio packets. For example, audio decoder 614 may include a combination of hardware and software configured to implement aspects of an audio codec. That is, audio decoder 614 may be configured to receive audio packets and provide audio data to audio output system 616 for rendering. Audio data may be coded using multi-channel formats such as those developed by Dolby and Digital Theater Systems. Audio data may be coded using an audio compression format. Examples of audio compression formats include Motion Picture Experts Group (MPEG) formats, Advanced Audio Coding (AAC) formats, DTS-HD formats, and Dolby Digital (AC-3, AC-4, etc.) formats. Audio output system 616 may be configured to render audio data. For example, audio output system 616 may include an audio processor, a digital-to-analog converter, an amplifier, and a speaker system. A speaker system may include any of a variety of speaker systems, such as headphones, an integrated stereo speaker system, a multi-speaker system, or a surround sound system.

Video decoder 618 may be configured to receive and process video packets. For example, video decoder 618 may include a combination of hardware and software used to implement aspects of a video codec. In one example, video decoder 618 may be configured to decode video data encoded according to any number of video compression standards, such as ITU-T H.262 or ISO/IEC MPEG-2 Visual, ISO/IEC MPEG-4 Visual, ITU-T H.264 (also known as ISO/IEC MPEG-4 Advanced video Coding (AVC)), and High-Efficiency Video Coding (HEVC). Display system 620 may be configured to retrieve and process video data for display. For example, display system 620 may receive pixel data from video decoder 618 and output data for visual presentation. Further, display system 620 may be configured to output graphics in conjunction with video data, e.g., graphical user interfaces. Display system 620 may comprise one of a variety of display devices such as a liquid crystal display (LCD), a plasma display, an organic light emitting diode (OLED) display, or another type of display device capable of presenting video data to a user. A display device may be configured to display standard definition content, high definition content, or ultra-high definition content.

I/O device(s) 622 may be configured to receive input and provide output during operation of receiver device 600. That is, I/O device(s) 622 may enable a user to select multimedia content to be rendered. Input may be generated from an input device, such as, for example, a push-button remote control, a device including a touch-sensitive screen, a motion-based input device, an audio-based input device, or any other type of device configured to receive user input. I/O device(s) 622 may be operatively coupled to receiver device 600 using a standardized communication protocol, such as for example, Universal Serial Bus protocol (USB), Bluetooth, ZigBee or a proprietary communications protocol, such as, for example, a proprietary infrared communications protocol.

Network interface 624 may be configured to enable receiver device 600 to send and receive data via a local area network and/or a wide area network. Network interface 624 may include a network interface card, such as an Ethernet card, an optical transceiver, a radio frequency transceiver, or any other type of device configured to send and receive information. Network interface 624 may be configured to perform physical signaling, addressing, and channel access control according to the physical and Media Access Control (MAC) layers utilized in a network. Receiver device 600 may be configured to parse a signal generated according to any of the techniques described above with respect to FIG. 6. In this manner, receiver device 600 represents an example of a device configured to receive a service level signaling metadata fragment from a broadcast stream, determine that media components forming the service are associated with a broadband delivery mechanism by parsing information from the metadata fragment, and retrieve the media components forming the service using the broadband delivery mechanism.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device (the video decoder and the video encoder) used in each of the afore-mentioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semi-conductor technology, the integrated circuit by this technology is also able to be used.

Various examples have been described. These and other examples are within the scope of the following claims.

1. A method for signaling information associated with one or more services associated with a data channel, the method comprising:
for each of the one or more services, signaling at least one of: a syntax element indicating media components forming the service are delivered over a broadcast mechanism and a syntax element indicating media components forming the service are delivered over a broadband mechanism, wherein a syntax element is signaled using service layer signaling; and
signaling a syntax element identifying a data channel corresponding to respective media delivery sessions including media components forming the one or more services using service layer signaling.

2. The method of claim 1, wherein the signaling a syntax element identifying a radio frequency channel includes signaling a child attribute of a service-based transport session instance description fragment.

3. The method of claim 2, wherein a cardinality of the child attribute is equal to one.

4. The method of claim 1, wherein signaling at least one of: a syntax element indicating media components forming the service are delivered over a broadcast mechanism and a syntax element indicating media components forming the service are delivered over a broadband mechanism, includes signaling a syntax element in a user service bundle descriptor fragment.

5. The method of claim 1, wherein a session includes a real-time object delivery over unidirectional transport session.

6. A method for signaling information associated with one or more services associated with a data channel, the method comprising:
for each media component of a service, signaling a syntax element identifying a data channel corresponding to respective media delivery sessions including the media component using service layer signaling; and
for each media component associated with a distinct service, signaling a syntax element identifying the distinct service using the service layer signaling.

7. A device for signaling information associated with one or more services associated with a data channel, the device comprising one or more processors configured to perform any and all combinations of the steps included in claim 1.

8. The device of claim 7, wherein the device includes a service distribution engine.

9. A device for parsing information associated with one or more services associated with a data channel information, the device comprising one or more processors configured to parse a signal generated according to any and all combinations of the steps included in claim 1.

10. The device of claim 9, wherein the device is selected from the group consisting of: a desktop, a laptop computer, a mobile device, a smartphone, a cellular telephone, a personal data assistant (PDA), a television, a tablet device, and a personal gaming device.

11. (canceled)

12. An apparatus for signaling information associated with one or more services associated with a data channel, the apparatus comprising means for performing any and all combinations of the steps included in claim 1.

13. A non-transitory computer-readable storage medium having instructions stored thereon that upon execution cause one or more processors of a device to perform any and all combinations of the steps included in claim 1.

14. A method for retrieving media components forming a service, the method comprising:
receiving a service level signaling metadata fragment from a broadcast stream;
determining that media components forming the service are associated with a broadband delivery mechanism by parsing information from the metadata fragment; and
retrieving the media components forming the service using the broadband delivery mechanism.
